(19) United States
(12) Patent Application Publication
(10) Pub. No.: US 2011/0163932 A1
(43) Pub. Date: Jul. 7, 2011

(54) Monolithically-Integrated Matched Antennas

(76) Inventor: H. Lee Mosbacker, Columbus, OH (US)

(21) Appl. No.: 12/985,046

(22) Filed: Jan. 5, 2011

Related U.S. Application Data
(60) Provisional application No. 61/292,214, filed on Jan. 5, 2010.

(51) Int. Cl. H01Q 21/08

(52) U.S. Cl. 343/824

(57) ABSTRACT

This disclosure relates to monolithic focal plane arrays including an antenna coupled to a backwards diode to make large scale arrays. The antennas may be, for example, a bow-tie antenna, a planar log-periodic antenna, a double-slot with microstrip feed antenna, a spiral antenna, a helical antenna, a ring antenna, a dielectric rod antenna, or a double slot antenna with co-planar waveguide feed antenna. There is no restriction on the type of antenna coupled with the backwards diodes to make monolithic large scale arrays.

### CROSS-REFERENCE TO RELATED APPLICATIONS

This application claims benefit of provisional application Ser. No. 61/292,214 filed on Jan. 5, 2010 and entitled “Monolithically-Integrated Matched Antennas”; and is cross-referenced to application Ser. No. 12/789,805, filed on May 28, 2010 and entitled “Miniature Phase-Corrected Antennas for High Resolution Focal Plane THz Imaging Arrays”; the disclosures of which are expressly incorporated herein by reference.

### STATEMENT REGARDING FEDERALLY SPONSORED RESEARCH

Not applicable.

### BACKGROUND

Non-ionizing and penetrative nature of terahertz (THz) radiation makes it promising for various detection methods in the commercial and defense industry [1-2]. Likewise, in the medical scene, particular bands in the THz frequency regime can be identified as markers of malignant tissues. Tuned to these marker frequencies, THz radiation recently has been proposed as an effective tool for cancer detection that will exhibit satisfactory resolution, substantial penetration depth, and non-harmful radiation properties in contrast to the x-ray technology. This is especially true and important for the case of breast cancer with recently identified marker frequencies of 500 and 800 GHz. According to 2006 American Cancer Society surveillance research, one out of eight women will have breast cancer in their lifetime with 96% of these cases being curable if early detected. Moreover, real-time viewing and identification of the excised tissues during medical operation is highly desired in order to decrease the biopsy time and number of follow up operations.

Medical images using THz radiation typically are generated through a mechanical raster scan of the object. However, long image acquisition times associated with such a raster scan constitute a major bottleneck. Therefore, rapid THz imaging systems based on large arrays of sensitive detectors recently have been considered within the commercial and scientific communities. In the work disclosed herein, a focal plane imaging array topology with low noise and highly sensitive heterojunction detector diodes is developed. Specifically, we consider two major needs associated with the resolution of the THz imaging arrays constructed on extended hemispherical lenses. These needs include:

(1) Compact THz detector layout for tightly packed 2D focal plane imaging arrays. For example, Schottky diodes monolithically integrated within double slot antennas were previously employed in heterodyne THz detectors settings. Although these detectors are attractive in conjunction with the double slot antennas (because of their high Gaussian beam coupling efficiency and diffraction limited patterns [3]), the need for local oscillator signal and relatively large low-pass IF filter sections do not allow for tightly packed array development.

(2) Large number of antenna/detector elements (or equivalently pixels) without resorting to expensive and bulky lenses. When an extended hemispherical lens is used to focus the image on the array elements, reflections at the lens/air boundary significantly reduce coupling efficiency of the pixels positioned away from the lens axis. Therefore, the number of detector elements is significantly limited by the lens diameter, and cannot support imaging for scan angles beyond ±20° [4].

To alleviate these issues, in this disclosure, we disclose and verify a dual slot antenna element integrated with a zero-biased Sb-heterostructure backward diode [5] for direct detection of THz radiation. In addition, we consider improved antenna layouts that can support tilted radiation patterns in order to increase the number of detectors without resorting to expensive and large silicon lenses.

A general discussion of HBD structures is set forth in U.S. Pat. No. 6,635,907. An improved version of such HBD is used in the present disclosure. In particular, the Sb-heterostructure backward diode of use in the present disclosure is an InAs/AlSb/GaSb backward diode having a p-type δ-doping plane with sheet concentration of 1×10¹² cm⁻² in the n-InAs cathode layer, as disclosed in the following references: N. Su, R. Rajavel, P. Deelman, J. N. Schulman, and P. Fay, “Sb-Heterostructure Millimeter-Wave Detectors With Reduced Capacitance and Noise Equivalent Power,” IEEE Electron Device Letters, vol. 29, no. 6, pp. 536-539, June 2008; Su, Zhang, Schulman, and Fay, “Temperature Dependence of High Frequency and Noise Performance of Sb-Heterostructure Millimeter-Wave Detectors,” IEEE Electron Device Letters, Vol. 28, No. 5, May 2007; Fay, Schulman, Thomas, III, Chow, Boegeman, and Holabird, “High-Performance Antimonide-Based Heterostructure Backward Diodes for Millimeter-Wave Detection,” IEEE Electron Device Letters, Vol. 23, No. 10, October 2002; and WO/2010/06966 published Feb. 22, 2010 (corresponding to PCT/US09/45288 filed on May 27, 2009). The disclosures of all of these references are expressly incorporated herein by reference.

Such preferred backward diodes as referenced immediately above can be described as a “cathode layer adjacent to a first side of a non-uniform doping profile, and an Antimonide-based tunnel barrier layer adjacent to a second side of the spacer layer having monolithically integrated antennas bonded thereto”. The Antimonide-based tunnel barrier of such backward diodes may be doped. Such doping may be a non-uniform delta doping profile. This HBD, then, will be referred to herein as “a cathode layer adjacent to a first side of a non-uniform doping profile, and an Antimonide-based tunnel barrier layer adjacent to a second side of the spacer layer” for ease in discussion.

Application Ser. No. 12/789,805 discloses an array of backward diodes of a cathode layer adjacent to a first side of a non-uniform doping profile and an Antimonide-based tunnel barrier layer adjacent to a second side of the spacer layer have a monolithically integrated antenna bonded to each backward diode. The Antimonide-based tunnel barrier may be doped with, for example, a non-uniform delta doping profile. An imaging/detection device includes a 2D focal plane array of an array of backward diodes, wherein each backward diode is monolithically bonded to an antenna, which array is located at the back of an extended hemispherical lens, and wherein certain of the arrays are tilted for correcting optics aberrations. The antennas may be a bow-tie antenna, a planar log-periodic antenna, a double-slot with microstrip feed antenna, a spiral antenna, a helical antenna, a ring antenna, a dielectric rod antenna, or a double slot antenna with co-planar waveguide feed antenna.

### BRIEF SUMMARY

This disclosure relates to monolithic focal plane arrays including an antenna coupled to a backwards diode to make large scale arrays. The antennas may be, for example, a bow-tie antenna, a planar log-periodic antenna, a double-slot with microstrip feed antenna, a spiral antenna, a helical antenna, a ring antenna, a dielectric rod antenna, or a double slot antenna with co-planar waveguide feed antenna. There is no restriction on the type of antenna coupled with the backwards diodes to make monolithic large scale arrays.

### BRIEF DESCRIPTION OF THE DRAWINGS

For a fuller understanding of the nature and advantages of the present device, reference should be had to the following detailed description taken in connection with the accompanying drawings, in which:

FIG. 1 is a fabricated dual slot antenna receiver for direct detection at 100 GHz;

FIG. 2 is an enlarged view of the fabricated dual slot antenna receiver of FIG. 2;

FIG. 3 is an exemplary layout of a pattern corrected double slot antenna focal plane array (FPA).

These drawings will be described in further detail below.

### DETAILED DESCRIPTION

HBD elements constituting the single-pixel detectors leverage the strongly asymmetric current-voltage characteristic enabled by the unique band alignments present in the InAs/AlSb/GaSb material system. This unique alignment enables a high sensitivity with no applied DC bias. The elimination of DC biasing results in simpler system architecture, but most importantly eliminates 1/f noise in the detector. Implementing this strategy with a device structure developed elsewhere has demonstrated noise equivalent powers (NEP) as low as 240 fW/Hz^{1/2}.¹ This sensitivity is sufficient to enable passive imaging arrays based on direct detection, without requiring either cryocooling or low-noise amplifier (LNA) front-ends. This reduces not only the cost, but also the front-end engineering needed for arrays based on these materials. Improved noise performance translates directly into improved system signal-to-noise ratio and reduced component part count and complexity. This detection array also involves a DC choke at each pixel. This choke directly converts from intensity-to-DC output on-chip, removing the requirement of transporting THz signals that results in large losses and has historically precluded a number of terahertz applications. ¹ N. Su, R. Rajavel, P. Deelman, J. N. Schulman, and P. Fay, “Sb-Heterostructure Millimeter-Wave Detectors with Reduced Capacitance and Noise Equivalent Power,” IEEE Electron Device Lett. 29, no. 6, pp. 536-539, 2008.

Prior work of others using custom-grown structures procured from HRL Laboratories LLC has demonstrated extremely low 1/f noise and an intrinsic sensitivity that exceeds the theoretical limits of thermionic devices (e.g., Schottky diodes, planar-doped barrier diodes). To date, these demonstrations have been limited to W-band and below (<110 GHz). This effort sees the aggressive scaling of deep-submicron devices for extending their frequency range into the THz regime. These nanoscale devices will be integrated with antennas to form broadband FPA arrays that operate in the 100 GHz through THz regime.

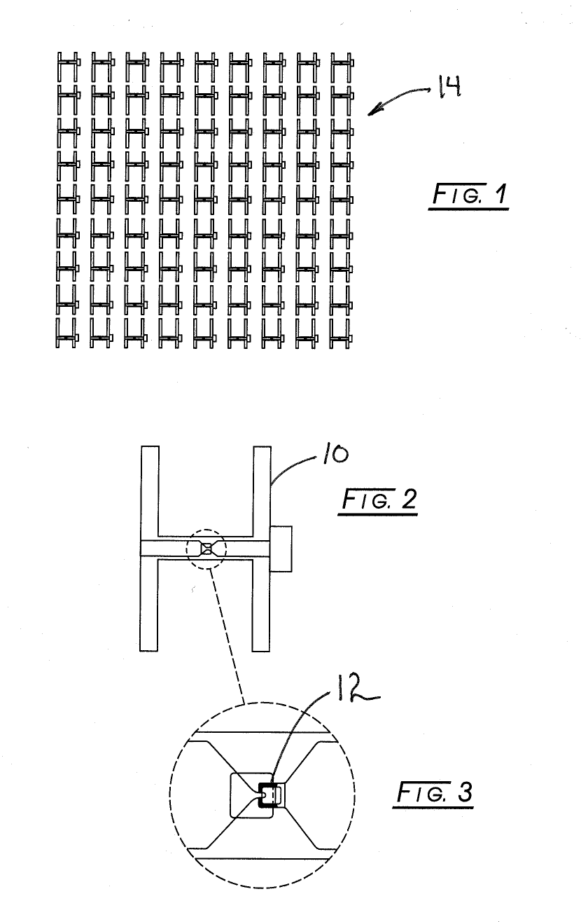

Current efforts have already demonstrated a scalable 6×11 FPA monolithically-integrated with matched antenna-diode structures.¹ After considering several alternative THz antenna architectures known in the art (for example, bow-tie antenna configuration, a planar log-periodic antenna configuration, a double-slot with microstrip feed antenna configuration, a spiral antenna configuration, a helical antenna configuration, a ring antenna configuration, a dielectric rod antenna configuration, or a double slot antenna with co-planar waveguide feed antenna configuration), the disclosed antenna design consists of a double-slot antenna element, 10, (see FIG. 2) printed on a high-resistivity silicon substrate and tuned to match the HBD's impedance at 0.1 THz. A 0.5 THz prototype has been demonstrated by scaling the design and re-tuning the impedance match to this particular frequency. This single element prototype is situated behind an extended hemispherical imaging lens. The placement of a HBD, 12, in double-slot antenna element 10 is seen in FIG. 4. An array, 14, of such double-slot antenna elements 10 is displayed in FIG. 1.

This first prototype was successfully tested using the standard setup. At the design frequency of 0.1 THz, this matched prototype achieved an unprecedented responsivity of R=100,000 V/W, and a noise equivalent power of NEP=0.2×10⁻¹². When scaled to 0.5 THz, the design sustains a responsivity >20,000 V/W with NEP<1×10⁻¹². There exists no other detector option offering this performance without a considerable form factor and liquid helium cryocooling requirements.

This monolithic integration of sensor element and antenna allows the team to flexibly modify the antenna topology. This modification can be done according to well-developed antenna design and microwave matching and filter theory techniques, in order to achieve a perfect match to the complex diode impedance. This highly promising integration of antenna and radiofrequency (RF) engineering is already opening up new avenues to develop a high-efficiency coupling of incident radiation into high-speed non-linear detectors. For example, similar approaches are being pursued to improve sensor responsivity and speed in the infrared (IR) and optical bands (using nano-antennas).

While the array and its use have been described with reference to various embodiments, those skilled in the art will understand that various changes may be made and equivalents may be substituted for elements thereof without departing from the scope and essence of the disclosure. In addition, many modifications may be made to adapt a particular situation or material to the teachings of the disclosure without departing from the essential scope thereof. Therefore, it is intended that the disclosure not be limited to the particular embodiments disclosed, but that the disclosure will include all embodiments falling within the scope of the appended claims. In this application all units are in the metric system and all amounts and percentages are by weight, unless otherwise expressly indicated. Also, all citations referred herein are expressly incorporated herein by reference.

### REFERENCES

[1]“A novel approach for improving off-axis pixel performance of THz focal plane arrays”, Trichopoulos, et al., IEEE MIT Special Issue on THz Technology

We claim:

1. A monolithic focal plane array, which comprises:
an array of backwards diodes coupled with antennas to make a large scale focal plane array.

2. The monolithic focal plane array of claim 1, wherein said antenna is one or more of a bow-tie antenna configuration, a planar log-periodic antenna configuration, a double-slot with microstrip feed antenna configuration, a spiral antenna configuration, a helical antenna configuration, a ring antenna configuration, a dielectric rod antenna configuration, or a double slot antenna with co-planar waveguide feed antenna configuration.

3. The monolithic focal plane array of claim 2, wherein said antenna is a double-slot antenna element.

4. The monolithic focal plane array of claim 1, wherein said antenna is printed on a high-resistivity silicon substrate and tuned to match the impedance of the backwards diode.
